(19) United States
(12) Patent Application Publication
(10) Pub. No.: US 2018/0106216 A1
(43) Pub. Date: Apr. 19, 2018

(54) NACELLE OF A TURBOJET ENGINE COMPRISING AN INVERTER FLAP

(71) Applicants: Airbus Operations SAS, Toulouse (FR); Airbus SAS, Blagnac (FR)

(72) Inventors: Nicolas JOLIVET, FONTENILLES (FR); Franck OUNDJIAN, BONREPOS SUR AUSSONNELLE (FR); Frédéric PIARD, TOURNEFEUILLE (FR); Vincent BILLEROT, FONSORBES (FR); Benoit LETAY, BOULOC (FR); Patrick OBERLE, VERDUN SUR GARONNE (FR); Thomas SAUVALLE, TOULOUSE (FR); Thierry SURPLY, CORNEBARRIEU (FR); Alain PORTE, COLOMIERS (FR)

(21) Appl. No.: 15/785,012

(22) Filed: Oct. 16, 2017

(30) Foreign Application Priority Data
Oct. 17, 2016 (FR) 1660018

(51) Int. Cl. F02K 1/62; F02K 1/76

(52) U.S. Cl. CPC F02K 1/62; F02K 1/763; F05D 2260/53; F05D 2240/14; F05D 2220/323

(57) ABSTRACT

A nacelle for a ducted fan turbojet engine comprising an engine. The nacelle comprises a fixed cowl, an upstream wall bounding off, with the engine, a working section for a secondary flow, a movable cowl with an interior wall and an exterior wall, and movable in translation between a closing position where the exterior wall adjoins the fixed cowl and the interior wall prolongs the upstream wall, and an opening position where the exterior wall is distant from the fixed cowl so as to open a window and the interior wall is distant from the upstream wall, an inverter flap between the interior wall and the exterior wall mounted to be free in rotation about an axis of rotation situated on the interior wall and a drive mechanism for moving the movable cowl.

### CROSS-REFERENCES TO RELATED APPLICATIONS

This application claims the benefit of the French patent application No. 1660018 filed on Oct. 17, 2016, the entire disclosures of which are incorporated herein by way of reference.

### TECHNICAL FIELD

The present invention concerns a nacelle for a ducted fan turbojet engine which comprises at least one inverter flap, a ducted fan turbojet engine comprising such a nacelle and an engine, as well as an airplane comprising at least one such ducted fan turbojet engine.

### BACKGROUND OF THE INVENTION

An airplane comprises a fuselage with a wing fixed to each side. Beneath each wing there is suspended at least one ducted fan turbojet engine. Each ducted fan turbojet engine is secured beneath the wing by means of a mast which is secured between the structure of the wing and the structure of the ducted fan turbojet engine.

The ducted fan turbojet engine comprises an engine and a nacelle which is secured around the engine.

The nacelle comprises at least one inverter flap which is movable between a closed position in which it is continuous with the exterior surface of the nacelle and an opened position in which it opens a window in the wall of the nacelle in order to expel the air of the secondary flow to the outside.

The inverter flap is mounted movable in rotation on the structure of the nacelle so as to move from a closed position where the inverter flap does not block the working section of the secondary flow to an open position where the inverter flap blocks the working section.

Thus, in the opened position, the inverter flap returns a portion of the secondary flow to the outside through the window. In the opened position, the inverter flap extends into the outside.

With the turbojet engines becoming increasingly large, the nacelle becomes larger and in order to prevent the portion of the inverter flap which is protruding from making contact with the wing it is necessary to move the nacelle away from the wing, which creates footprint problems.

It is thus necessary to provide a mechanism which limits the extension of the inverter flap outside the nacelle when the inverter flap is in the opened position.

### SUMMARY OF THE INVENTION

One purpose of the present invention is to propose a nacelle comprising at least one inverter flap with a different opening mechanism.

For this purpose, a nacelle for a ducted fan turbojet engine is proposed, comprising an engine, said nacelle comprising:
a fixed cowl,
an upstream wall bounding off, with the engine, a working section in which a secondary flow circulates,
a movable cowl comprising an interior wall and an exterior wall which surrounds the interior wall, said movable cowl being movable in translation along a direction of translation between a closing position in which, on the one hand, the exterior wall adjoins the fixed cowl and, on the other hand, the interior wall prolongs the upstream wall, and an opening position in which, on the one hand, the exterior wall is distant from the fixed cowl so as to open a window opening onto the exterior of the nacelle and, on the other hand, the interior wall is distant from the upstream wall, so as to open a passage between the working section and the window,
at least one inverter flap, each of them being arranged between the interior wall and the exterior wall, having a downstream end and an upstream end, situated upstream from the downstream end, and mounted to be free in rotation about an axis of rotation arranged on the side of the downstream end, and where the inverter flap is situated on the interior wall by its upstream end, and
a drive mechanism provided for moving the movable cowl in translation.

According to one particular embodiment, the drive mechanism comprises at least one jack mounted hinged between the movable cowl and a structure of the nacelle, and one control unit designed to control the lengthening and shortening of each jack.

Advantageously, each jack is outfitted with a brake which is controlled by the control unit and which locks the position of the jack.

According to another particular embodiment, the drive mechanism comprises at least one gear rack system, where each gear rack is secured to the movable cowl and aligned with the direction of translation, for each gear rack, a pinion secured to the structure of the nacelle to mesh with the teeth of the gear rack, a motor designed to drive each pinion in rotation, and a control unit provided to control the motor.

Advantageously, the nacelle comprises a roller mounted free in rotation about an axis perpendicular to the direction of translation and arranged on the interior wall in the area of its contact with the inverter flap.

Advantageously, the nacelle has at least one rod system comprising two rods hinged to each other, where one rod is mounted hinged to a structure of the nacelle and the other rod is mounted hinged to the inverter flap.

The invention likewise proposes a ducted fan turbojet engine comprising an engine and a nacelle according to one of the preceding variants, surrounding the engine, and where a working section of a secondary flow is bounded off between the nacelle and the engine.

The invention likewise proposes an airplane comprising at least one ducted fan turbojet engine according to the preceding variant.

### BRIEF DESCRIPTION OF THE DRAWINGS

The above-mentioned characteristics of the invention, as well as other ones, will appear more clearly from perusal of the following description of an example embodiment, said description being given in connection with the enclosed drawings, in which:

FIG. 1 is a side view of an airplane comprising a nacelle according to the invention,

FIG. 2 is a cross section along a median plane of the nacelle according to the invention in closed position,

FIG. 3 is a cross section similar to that of FIG. 2 in an intermediate position, and

FIG. 4 is a cross section similar to that of FIG. 2 in open position.

### DETAILED DESCRIPTION OF THE PREFERRED EMBODIMENTS

In the following description, the terms regarding a position refer to an airplane in position of advancement as represented in FIG. 1.

FIG. 1 shows an airplane 10 having a fuselage 12 on either side of which is fixed a wing 14 which carries at least one ducted fan turbojet engine 100 according to the invention. The fixation of the ducted fan turbojet engine 100 beneath the wing 14 is done by means of a mast 16.

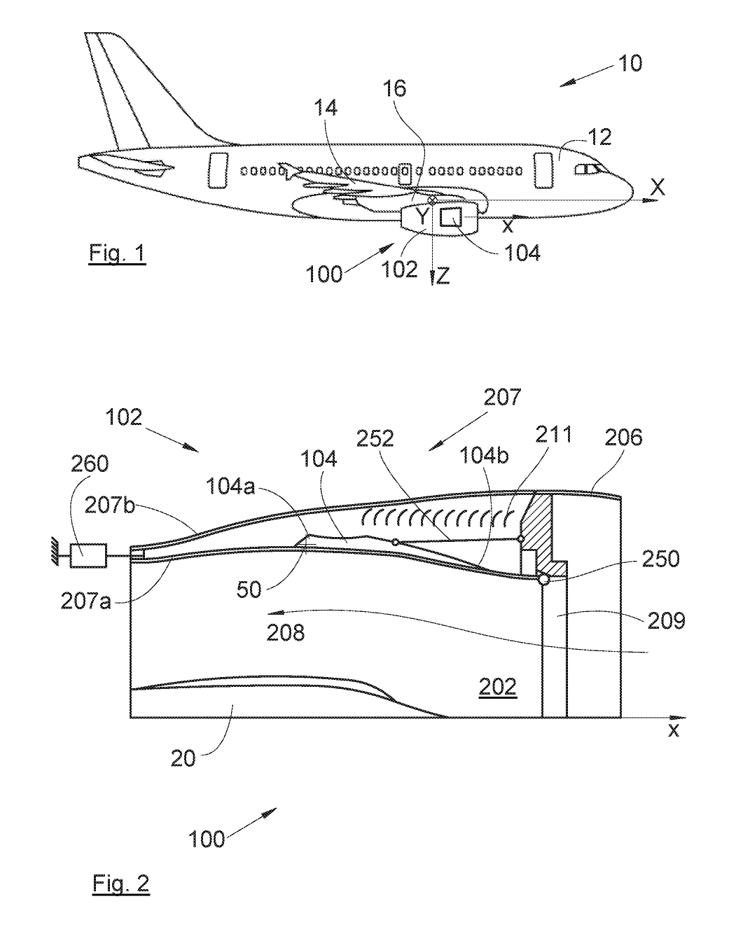

The ducted fan turbojet engine 100 comprises a nacelle 102 and an engine 20 which is lodged inside the nacelle 102. As is shown in FIGS. 2 to 4, the ducted fan turbojet engine 100 presents a working section 202 between the nacelle 102 and the engine 20 in which the secondary flow 208 circulates.

In the following description, and by convention, we shall call the longitudinal axis of the nacelle 102 the x axis, being parallel to the longitudinal axis X of the airplane 10 or the roll axis, oriented positive in the direction of advancement of the airplane 10, the transverse axis or pitch axis of the airplane is the Y axis, which is horizontal when the airplane is on the ground, and the vertical axis or vertical height or yaw axis is the Z axis when the airplane is on the ground, these three directions X, Y and Z being orthogonal to each other and forming an orthonormalized reference system having the center of gravity of the airplane as its origin.

The nacelle 102 comprises at least one inverter flap 104. In particular, it may have two inverter flaps 104 disposed one facing the other, or several of them, for example four inverter flaps 104 distributed equally on the periphery of the nacelle 102.

In the following description, the invention is described more particularly for one inverter flap 104, but it applies the same for each inverter flap 104 when there are several of them.

The nacelle 102 has a fixed cowl 206 which is mounted secured to a structure of the nacelle 102 and constitutes an exterior wall of the nacelle 102.

The nacelle 102 has, downstream from the fixed cowl 206 along the longitudinal axis x, a movable cowl 207 mounted movably in translation on the structure of the nacelle 102 in a direction of translation generally parallel to the longitudinal axis x. The translation is realized by any appropriate means, such as slideways.

The movable cowl 207 comprises an interior wall 207a and an exterior wall 207b which surrounds the interior wall 207a.

The nacelle 102 likewise has an upstream wall 209 which extends upstream from the interior wall 207a along the longitudinal axis x and constitutes an exterior wall of the working section 202 around the engine 20. The upstream wall 209 is fixed in relation to the structure of the nacelle 102 and situated substantially in the area of the front frame.

The movable cowl 207 is movable between a closing position (FIG. 2) in which the exterior wall 207b adjoins the fixed cowl 206 and an opening position (FIG. 4) in which the exterior wall 207b is distant from the fixed cowl 206 toward the rear, so as to open up a window 210 opening on the outside of the nacelle 102. In closing position, the fixed cowl 206 and the exterior wall 207b prolong each other to form the exterior envelope of the nacelle 102 and to block the window 210.

At the same time, in closing position, in the area of an upstream end, the interior wall 207a prolongs the upstream wall 209 and constitutes an exterior wall of the working section 202 around the engine 20 to channel the secondary flow 208, and in opening position the interior wall 207a is distant from the upstream wall 209 so as to open up the passage between the working section 202 and the window 210.

The window 210 is thus bounded off upstream by the fixed cowl 206 and downstream by the exterior wall 207b. In opening position, the window 210 is opened up between the working section 202 and the outside of the nacelle 102. The nacelle 102 has one such window 210 for each inverter flap 104.

The inverter flap 104 is disposed between the interior wall 207a and the exterior wall 207b and it is thus invisible in the closing position (FIG. 2).

The inverter flap 104 is mounted free in rotation about an axis of rotation 50 on the structure of the nacelle 102 between an inactive position (FIG. 2) in which it is not in the working section 202 (FIG. 2) and an active position (FIG. 4) in which it blocks at least part of the working section 202. According to one particular embodiment, the axis of rotation 50 is arranged on the rear frame of the nacelle 102.

When the movable cowl 207 is in the closing position, the inverter flap 104 is in the inactive position, and when the movable cowl 207 is in the opening position, the inverter flap 104 is in the active position so as to divert at least a portion of the secondary flow 208 to the outside of the nacelle 102.

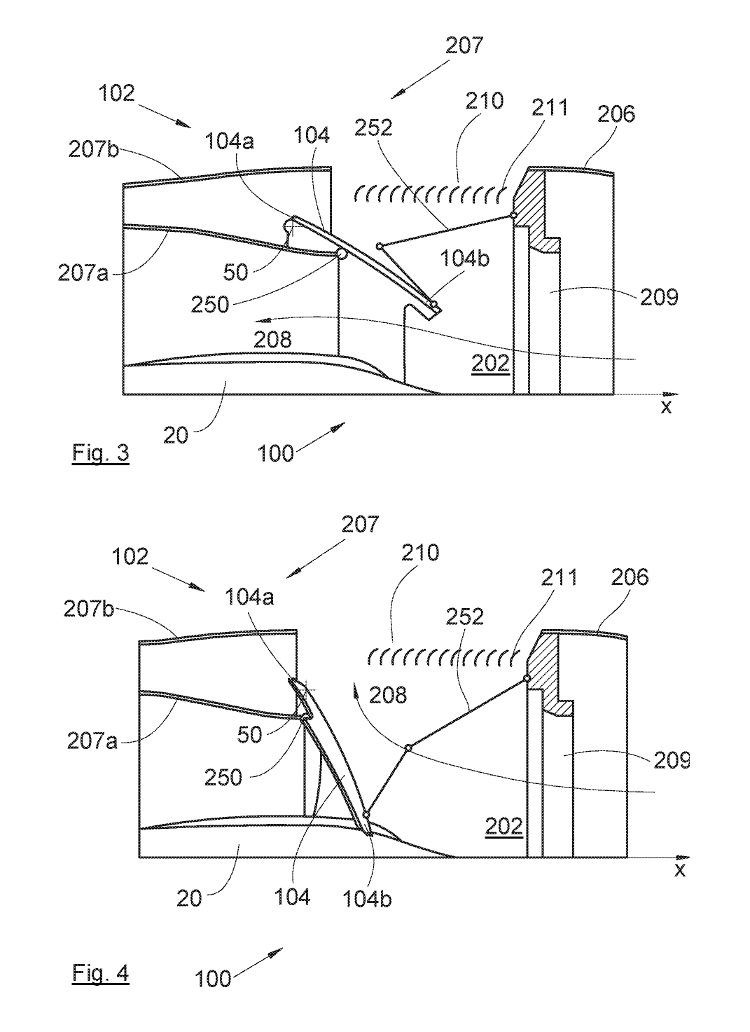

Between the closing/inactive position of FIG. 1 and the opening/active position of FIG. 4, the system takes up various intermediate positions, one of which is represented in FIG. 3.

The inverter flap 104 has a downstream end 104a and an upstream end 104b which is situated upstream from the downstream end 104a. The axis of rotation 50 of the inverter flap 104 is arranged on the side with the downstream end 104a of the inverter flap 104. The upstream end 104b of the inverter flap 104 lies against the interior wall 207a.

Thus, in the closing/inactive position (FIG. 2), the window 210 is closed, the inverter flap 104 rests against the interior wall 207a by its upstream end 104b and is not located in the working section 202. In order to move into the opening/active position, the movable cowl 207 is then displaced toward its opening position, that is, in translation to the rear, and since the inverter flap 104 is not displaced along with the movable cowl 207, the movable cowl 207 slides beneath the inverter flap 104 and as the movable cowl 207 continues to be displaced, the upstream end 104b of the inverter flap 104 is situated increasingly upstream in relation to the upstream end of the interior wall 207a. Since the inverter flap 104 bears against the upstream end of the interior wall 207a, it tilts about the axis of rotation 50 to end up in the working section 202 in its active position (FIG. 4).

On the contrary, from the opening/active position, the displacement of the movable cowl 207 toward its closing position brings the inverter flap 104 back to its inactive position by sliding of the interior wall 207a beneath the inverter flap 104.

Such an arrangement avoids the inverter flap 104 emerging from the nacelle 102.

The moving from the closing position to the opening position of the movable cowl 207 is thus coordinated with the moving from the inactive position to the active position of the inverter flap 104 and vice versa.

The movable cowl 207 is displaced in translation by any suitable drive mechanism 260.

For example, the drive mechanism is constituted by at least one jack mounted hinged between the movable cowl 207 and the structure of the nacelle 102. Each jack can be electrical, hydraulic, pneumatic, or some other type.

The drive mechanism likewise comprises a control unit, of the processor type, which controls the lengthening and the shortening of each jack according to the needs of the airplane 10.

In order to ensure the locking of the opening position of the movable cowl 207, each jack is outfitted with a brake, or a bolt, which is controlled by the control unit and which locks the position of the jack.

It is likewise possible to provide that the movable cowl 207 is maintained in its opening position by a set of bolts ensuring the maintaining of the movable cowl 207 in the opening position.

According to another particular embodiment, the drive mechanism is constituted, for example, by at least one gear rack system. Each gear rack is secured to the movable cowl 207 and aligned with the direction of translation, and for each gear rack the drive system comprises one pinion fixed to the structure of the nacelle 102 and movable in rotation about an axis perpendicular to the direction of translation to mesh with the teeth of the gear rack. The drive mechanism likewise comprises a motor controlled by a control unit and arranged to drive each pinion in rotation. The transmission of movement between the motor and each pinion is done via a transmission system which may comprise gearings, flexible transmission axles, or other elements. The control unit is of the same type as the preceding.

The motor may be hydraulic or electric or another type.

To ensure a better sliding of the interior wall 207a beneath the inverter flap 104, the nacelle 102 comprises a roller 250 mounted free in rotation about an axis perpendicular to the direction of translation x and arranged on the interior wall 207a in the area of its contact with the inverter flap, that is, generally in the area of its upstream end.

In order to prevent the inverter flap 104 from being jammed in the active position, the nacelle 102 has at least one rod system 252 mounted between the structure of the nacelle 102, here the front frame, and the inverter flap 104. Each rod system 252 comprises two rods hinged to each other, where one rod is mounted hinged to the structure of the nacelle 102 and the other rod is mounted hinged to the inverter flap 104. The maximum lengthening of the rods corresponds to the position beyond which the inverter flap 104 may not travel.

The nacelle 102 may be equipped with deflection grids 211, also known as “cascades,” which are disposed across the window 210 to improve the efficiency of the inverter by more precisely controlling the direction of a diverted secondary flow 208.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A nacelle for a ducted fan turbojet engine comprising an engine, said nacelle comprising:
a fixed cowl,
an upstream wall bounding off, with the engine, a working section in which a secondary flow circulates,
a movable cowl comprising an interior wall and an exterior wall which surrounds the interior wall, said movable cowl being movable in translation along a direction of translation between a closing position in which, on the one hand, the exterior wall adjoins the fixed cowl and, on the other hand, the interior wall prolongs the upstream wall, and an opening position in which, on the one hand, the exterior wall is distant from the fixed cowl so as to open a window opening onto the exterior of the nacelle and, on the other hand, the interior wall is distant from the upstream wall, so as to open a passage between the working section and the window,
at least one inverter flap, each of them being arranged between the interior wall and the exterior wall, having a downstream end and an upstream end, situated upstream from the downstream end, and mounted to be free in rotation about an axis of rotation arranged on the side of the downstream end, and where the inverter flap is situated on the interior wall by its upstream end, and
a drive mechanism provided for moving the movable cowl in translation.

2. The nacelle according to claim 1, wherein the drive mechanism comprises at least one jack mounted hinged between the movable cowl and a structure of the nacelle, and one control unit configured to control the lengthening and shortening of each jack.

3. The nacelle according to claim 2, wherein each jack is outfitted with a brake which is controlled by the control unit and which locks the position of the jack.

4. The nacelle according to claim 1, wherein the drive mechanism comprises at least one gear rack system, where each gear rack is secured to the movable cowl and aligned with the direction of translation, for each gear rack, a pinion secured to the structure of the nacelle to mesh with the teeth of the gear rack, a motor designed to drive each pinion in rotation, and a control unit provided to control the motor.

5. The nacelle according to claim 1, further comprising a roller mounted free in rotation about an axis perpendicular to the direction of translation and arranged on the interior wall in the area of its contact with the inverter flap.

6. The nacelle according to claim 1, further comprising at least one rod system comprising two rods hinged to each other, where one rod is mounted hinged to a structure of the nacelle and the other rod is mounted hinged to the inverter flap.

7. A ducted fan turbojet engine comprising an engine and a nacelle according to claim 1 surrounding the engine, and where a working section of a secondary flow is bounded off between the nacelle and the engine.

8. An airplane comprising at least one ducted fan turbojet engine according to claim 7.
